(19) United States
(12) Patent Application Publication
(10) Pub. No.: US 2003/0104783 A1
(43) Pub. Date: Jun. 5, 2003

(54) Adaptive electromagnetic interference rejection system and method

(75) Inventor: Frank X. Linder, Oxford, CT (US)

Correspondence Address: Raymond A. Nuzzo, Law Offices of Raymond A. Nuzzo, LLC, 579 Thompson Avenue, East Haven, CT, 06512, US

(73) Assignee: Esion-Tech, LLC

(21) Appl. No.: 10/005,521

(22) Filed: Dec. 4, 2001

(51) Int. Cl. H04B 1/10

(52) U.S. Cl. 455/63; 455/67.1

(57) ABSTRACT

An adaptive radio frequency (RF) electromagnetic interference rejection system and method. An RF information signal having an information signal component and an interfering electromagnetic signal component that has a varying characteristic frequency is delayed by a reference delay time that is equal that is equal to a predetermined number of periods of the characteristic frequency to form a delayed RF information signal. The delayed RF information signal is subtracted from the non-delayed RF information signal to form a processed RF information signal in which the information component is substantial and the interfering electromagnetic signal component is negligible. The amplitude of the interfering electromagnetic signal component of the processed RF information signal is constantly monitored. The delay of the delayed RF information signal is varied as the characteristic frequency of the interfering electromagnetic signal component changes so as to maintain the amplitude of the interfering electromagnetic signal component of the processed RF information signal at a minimum level.

### BACKGROUND OF THE INVENTION

1. Field of the Invention

The present invention relates to electromagnetic interference rejection systems, and more particularly, to a system and method for rejecting an interfering electromagnetic signal in an information signal.

2. Problem to be Solved

Communication systems are often subject to interfering electromagnetic signals in the RF (radio frequency) spectrum. Such interfering electromagnetic signals can be caused in several ways and emanate from a variety of sources. For example, spurious emissions and unfiltered harmonic frequencies generated by RF transmitters, oscillators or other RF generating devices can cause such interfering signal signals. Transmitters that output jamming signals also generate such interfering electromagnetic signals. Communication systems and RF signal processing systems that operate on all parts of the RF spectrum (i.e. low RF to microwave) are subject to interference and distortion by such interfering electromagnetic signals. What is needed is an adaptive electromagnetic interference rejection system that can be used with any portion of the RF spectrum ranging from relatively low RF to microwave frequencies.

### SUMMARY OF THE INVENTION

In one aspect, the present invention is directed to a method of rejecting an interfering signal which has been introduced into an information signal, comprising the steps of receiving an information signal having an information component and an interfering component having a varying characteristic frequency, delaying the information signal by a reference delay time that is equal to a predetermined number of periods of the characteristic frequency to form a delayed information signal, subtracting the delayed information signal from the information signal to form a processed information signal in which the information component is substantial and the interfering component is negligible, determining the amplitude of the interfering component of the processed information signal, and varying the delay of the information signal as the characteristic frequency of the interfering signal component changes in order to maintain the amplitude of the interfering component of the processed information signal at a minimum level.

In a related aspect, the present invention is directed to an apparatus for rejecting an interfering signal introduced into an information signal. In one embodiment, the apparatus comprises an RF signal input interface for receiving an RF signal having an information component and an interfering signal component having a varying characteristic frequency, circuitry and components for delaying the RF signal by a reference delay time that is equal to a predetermined number of periods of the characteristic frequency to form a delayed RF signal, circuitry and components for processing the RF signal and the delayed RF signal to form a processed reference RF signal in which the information component is substantial and the interfering signal component is negligible, circuitry and components for determining the amplitude of the interfering signal component of the processed reference RF signal, and circuitry and components for varying the delay of the RF signal as the characteristic frequency of the interfering signal component changes in order to maintain the interfering signal component of the processed reference RF signal at a minimum level.

### BRIEF DESCRIPTION OF THE DRAWINGS

FIG. 1 is a block diagram of one embodiment of the adaptive electromagnetic interference rejection system of the present invention.

FIG. 2 illustrates particular operating conditions of the adaptive electromagnetic interference rejection system of the present invention.

FIG. 3 is a block diagram of another embodiment of the adaptive electromagnetic interference rejection system of the present invention.

FIG. 4 is a block diagram of a further embodiment of the adaptive electromagnetic interference rejection system of the present invention.

FIG. 5 is a block diagram of another embodiment of the adaptive electromagnetic interference rejection system of the present invention.

FIG. 6 is a block diagram of a further embodiment of the adaptive electromagnetic interference rejection system of the present invention.

FIG. 7 is a block diagram of another embodiment of the adaptive electromagnetic interference rejection system of the present invention.

### DETAILED DESCRIPTION OF THE PREFERRED EMBODIMENT

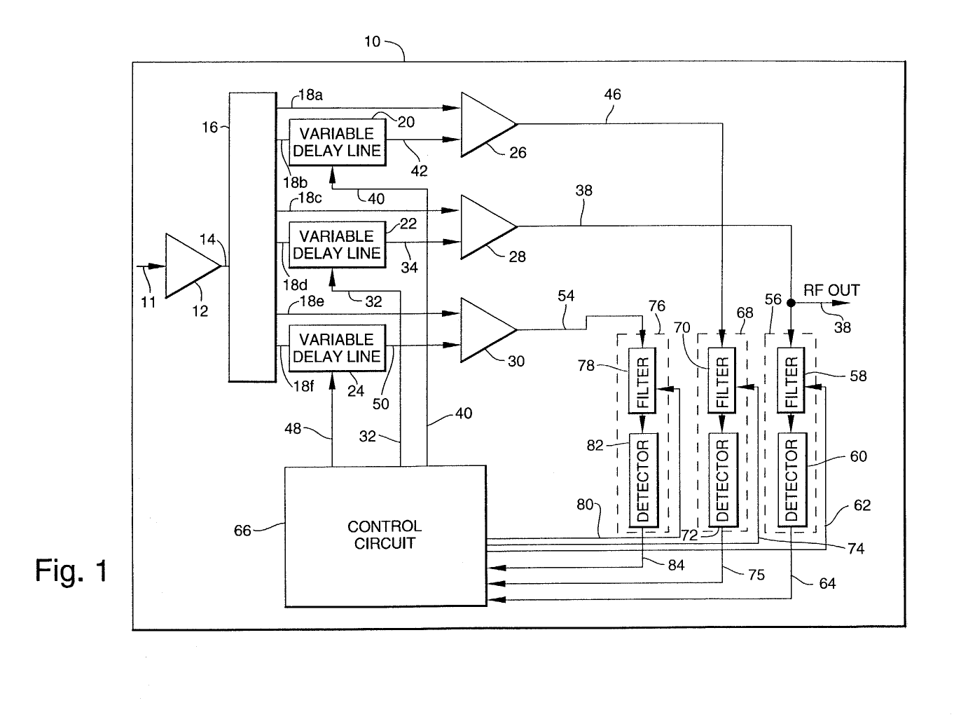

FIG. 1 schematically illustrates one embodiment of the adaptive electromagnetic interference rejection system 10 of the present invention. System 10 is configured for use with relatively low radio frequencies that can be processed or manipulated with discrete components or circuitry. RF input signal 11 contains an information signal component and an interference or interfering signal component and is inputted into RF amplifying device 12 which amplifies RF input signals 11. Signal 11 can be provided by an antenna or another RF stage that precedes system 10. Amplifying device 12 may be realized by a commercially available RF amplifier that has sufficient bandwidth. The gain of amplifying device 12 depends upon the application in which system 10 is used. Amplifying device 12 outputs amplified information signal 14 that contains an information component and an interference component. The interference component has a characteristic frequency and an associated period. Amplified information signal 14 is inputted into a six-way power splitter or divider 16. Power splitter or divider 16 outputs signals 18a-f.

Referring to FIG. 1, signals 18b, 18d, and 18f are inputted into variable delay lines 20, 22 and 24, respectively. Signals 18a, 18c and 18e are directly inputted into differential amplifiers 26, 28 and 30, respectively. Variable delay line 22 has an input for receiving a control signal 32 and an output for outputting delayed information signal 34. Control signal 32 determines a predetermined reference time delay that is to be exhibited by variable delay line 22. The generation of control signal 32 is discussed in the ensuing description. The predetermined delay is a function of the period associated with the current characteristic frequency of the interference component of signal 14. This predetermined time delay is referred to herein as the “reference delay”. The reference delay can be any number of periods of the characteristic frequency of the interfering signal component. In one embodiment, the reference delay corresponds to one full period of the interfering component that is to be rejected. For purposes of the ensuing description, the reference delay will correspond to one period (i.e. one wavelength or one lambda) of the characteristic frequency of the interfering signal component. The characteristic frequency, as mentioned above, may vary with time but may be treated generally as a constant within the brief delay times associated with a few periods of the interfering signal component. Variable delay line 22 delays signal 18d by the reference delay so as to produce delayed signal 34. Signals 18c and 34 are inputted into differential amplifier 28. Differential amplifier 28 outputs a processed signal 38 that represents the difference between non-delayed signal 18c and delayed signal 34. Processed signal 38 is the main system output signal which is inputted into other signal processing devices (not shown).

Variable delay line 20 has an input for receiving control signal 40 and an output for outputting delayed signal 42. Control signal 40 determines a second predetermined delay that is to be exhibited by variable delay line 20. The second predetermined delay is greater than the reference delay. The generation of control signal 40 is discussed in the ensuing description. If the reference delay is one wavelength of the characteristic frequency of the interfering signal component to be suppressed or cancelled, the predetermined second delay is greater than one wavelength. The actual difference between the second predetermined delay and the reference delay remains constant. Non-delayed signals 18a and delayed signal 42 are inputted into differential amplifier 26. Differential amplifier 26 outputs a processed signal 46 that represents the difference between signals 18a and 42.

Variable delay line 24 has an input for receiving a control signal 48 and an output for outputted delayed signal 50. Control signal 48 controls delay line 24 to exhibit a third predetermined delay that is to be exhibited by delay line 24. The third predetermined delay is relatively less than the reference delay. Thus, if the reference delay is one wavelength of the characteristic frequency of the interfering signal component to be suppressed or cancelled, the predetermined third delay is relatively less than one wavelength. The actual difference between the third predetermined delay and the reference delay remains constant. Signals 18e and 50 are inputted into differential amplifier 30. Differential amplifier 30 outputs a processed signal 54 that represents the difference between signals 18e and 50. The generation of control signal 48 is discussed in the ensuing description.

The variation of the delays of variable delay lines 20, 22 and 24 is effected by a “ganged” configuration so that the difference between the second predetermined delay and the reference delay remains constant, the difference between the third predetermined delay and the reference delay remains constant, and the difference between the second and third predetermined delays remain constant.

As described in the foregoing description, information signal 18c (also referred to herein as “non-delayed information signal”) and delayed information signal 34 are inputted into differential amplifier circuit 28 which, in essence, subtracts the level of the delayed information signal 34 from that of the non-delayed information signal 18c to form a processed information signal 38 in which the level of the information component is substantial and the level of the interfering signal component is negligible. The effect of the foregoing processing is to cancel the interfering signal component of the information signal while substantially maintaining the information signal component of signal 14. Processed information signal 38 is the main system output and is made available for use with other signal processing components or devices (not shown). Signal 38 is also inputted into receiving circuit 56. In one embodiment, receiving circuit 56 comprises a tuned filter 58 and an amplitude detector 60. In one embodiment, tuned filter 58 is a variable band pass filter having a variable center frequency Fc. In a preferred embodiment, center frequency Fc is varied by control signal 62. This feature is discussed in detail in the ensuing description. The center frequency Fc is equal to the current characteristic frequency of the interfering signal component of information signal 14. Filter 58 removes the information component from the processed information signal 38 and outputs any remaining interfering signal component. The output of filter 58 is then inputted into amplitude detector 60. Amplitude detector 60 outputs a signal 64 that represents the amplitude or level of the interfering signal component outputted by filter 58. Signal 64 is then inputted into control circuit 66. The purpose of this configuration is discussed in detail in the ensuing description.

As described in the foregoing description, variable delay circuit 20 outputs delayed information signal 42. Delayed information signal 42 is inputted into differential amplifier 26 which subtracts the level of delayed information signal 42 from that of non-delayed digital information signal 18a to form processed information signal 46. Since the delay of delayed information signal 42 is greater than the reference delay, the delay of signal 42 is not associated with the period of the current characteristic frequency of the interfering signal component, but rather, is associated with a relatively lower frequency. Thus, the amplitude or level of the interfering signal component of processed information signal 46 is substantially higher than the amplitude or level of the interfering signal component of processed information signal 38.

Signal 46 is inputted into receiving circuit 68. In one embodiment, receiving circuit 68 comprises a tuned filter 70 and an amplitude detector 72. In one embodiment, filter 70 is a variable band pass filter having a variable center frequency Fc. In a preferred embodiment, center frequency Fc is varied by control signal 74. The generation of control signal 74 is discussed in detail in the ensuing description. The center frequency Fc is equal to the current characteristic frequency of the interfering signal component of information signal 14. Filter circuit 70 removes the information component from the processed information signal 46 and outputs any remaining interfering signal component. The output of filter circuit 70 is then inputted into amplitude detector 72. Amplitude detector 72 outputs signal 75 that represents the amplitude or level of the interfering signal component outputted by filter 70. Signal 75 is then inputted into control circuit 66. The purpose of this configuration is discussed in detail in the ensuing description.

As described in the foregoing description, variable delay line 24 outputs delayed information signal 50. The delay of information signal 50 is relatively less than the reference delay of information signal 34 and thus corresponds to a frequency that is relatively higher than the characteristic frequency of the interfering signal component. Delayed information signal 50 is inputted into differential amplifier 30 that subtracts the level of delayed information signal 50 from that of non-delayed information signal 18e to form processed information signal 54. Therefore, the amplitude or level of the interfering signal component of processed signal 54 is substantially higher than the amplitude or level of the interfering signal component of processed information signal 38. Processed information signal 54 is then inputted into receiver circuit 76. In one embodiment, receiver circuit 76 comprises tuned filter 78. In one embodiment, filter 78 is configured as variable band pass filter as described in the foregoing description. Filter 78 has a center frequency Fc that is equal to the current frequency of the interfering signal component of information signal 14. The center frequency Fc is varied by control signal 80. Filter 78 filters processed information signal 54 so as to remove the information component and pass only the interfering signal component. Receiver circuit 76 further includes amplitude detector 82. The output of filter 78 is then inputted into amplitude detector 82. Amplitude detector 82 outputs signal 84 that represents the amplitude or level of the interfering signal component of the signal outputted by filter 78. The purpose of this configuration will be discussed in detail in the ensuing description.

Control circuit 66 receives signals 64, 75 and 84 outputted by amplitude detector 60, 72 and 82, respectively. Control circuit 66 contains circuitry that effects comparison of the amplitudes represented by signals 64, 75 and 84 to determine whether the amplitude represented by signal 64 is relatively lower than the amplitudes represented by signals 75 and 84. If control circuit 66 determines that the amplitude represented by signal 64 is lower than the amplitudes represented by signals 75 and 84, then control circuit 66 outputs control signals 32, 40 and 48 that are inputted into variable delay lines 22, 20 and 24, respectively, so as to maintain the current reference time delay. Control circuit 66 also outputs control signals 62, 74 and 80 that are inputted into filters 58, 70 and 78, respectively, to maintain the current center frequency Fc of the pass band of these filters.

In a preferred embodiment, filters 58, 70 and 78 are all the same type of filter, i.e. all band pass filters, all high pass filter, all low pass filters, etc. In a preferred embodiment, filters 58, 70 and 78 are configured in a “ganged” configuration so that the center frequency Fc of the band passes of all of the filters is varied simultaneously. In a preferred embodiment, the tuning of filters 58, 70 and 78 occurs simultaneously with the adjustment of the delays of delay lines 20, 22 and 24.

If the characteristic frequency of the interfering signal component of information signal 14 increases or decreases, the current reference delay will not be equal to the period of the new characteristic frequency of the interfering signal component. Therefore, there will be minimum or no cancellation of the interfering signal component in differential amplifier 28. As a result, the amplitude or level of the interfering signal component of processed information signal 38 increases significantly.

System 10 implements an initialization process in order to determine the initial reference time delay because the characteristic frequency of the interfering signal component of information signal 11 is not initially known. When system 10 is activated, RF signals 11 are inputted into RF amplifier 12 and control circuit 66 outputs a sequence of control signals 32, 40 and 48 that control variable delay lines 22, 20 and 24 respectively, to increase the reference delay in graduations starting from an initial reference time delay to a maximum reference time delay. In a preferred embodiment, the initial and reference time delays cover radio frequencies that can be processed or manipulated with discrete circuitry and discrete components. As control circuit 66 sweeps through this range of time delays, control circuit 66 simultaneously outputs a corresponding sequence of control signals 62, 74 and 80 that vary the center frequency Fc of the pass band of each filter 58, 70 and 78 so that the center frequency Fc corresponds to the particular reference delay at that point in time. As the center frequency Fc and the delay of the delay lines are varied, control circuit 66 monitors the amplitudes represented by signals 64, 75 and 84. Specifically, control circuit 66 stores in memory the particular reference time delay that causes the amplitude or level represented by signal 64 to be relatively lower than the amplitudes represented by the signals 75 and 84. Normal operation of system 10 can begin once control circuit 66 completely sweeps the range of possible reference time delays and stores the relevant reference time delays in memory. Normal operation of system 10 then begins using the stored reference time delay.

As the characteristic frequency of the interfering signal component of information signal 11 increases, the reference time delay of delay line 22 is no longer equal to the period of the characteristic frequency of interfering signal component. As a result, the amplitude of the interfering signal component of processed information signal 38 substantially increases because there is now only minimal cancellation of the interfering signal component. Since the characteristic frequency has increased, and the delay of signal 50 corresponds to a frequency that is relatively higher than the initial characteristic frequency of the interfering signal component, the amplitude or level of the interfering signal component of the processed information signal 54 substantially decreases. Subsequently, control circuit 66 now determines that the amplitude or level of the interfering signal component of processed information signal 84 is now relatively lower than the amplitudes or levels of the interfering signal component of processed information signals 64 and 75. Control circuit 66 then outputs control signal 32 which effects a decrease in the reference time delay created by variable delay line 22 so as to provide a new reference time 71b delay that is equal to the period of the new characteristic frequency of the interfering signal component. Control circuit 66 also outputs control signals 40 and 48 that vary the delays of variable delay lines 20 and 24, respectively, so that the delay created by delay line 20 is relatively greater than the new reference delay and the delay of delay line 24 is relatively less than the new reference delay. Control signal 66 also shifts the center frequency Fc of the band pass of each filter 58, 70 and 78, via control signals 62, 74 and 80, respectively, to the new characteristic frequency of the interfering signal component.

As the characteristic frequency of the interfering signal component of information signal 11 decreases, the reference time delay is no longer equal to the period of the characteristic frequency of interfering signal component. As a result, the amplitude of the interfering signal component of processed information signal 38 substantially increases because there is now only minimal cancellation of the interfering signal component. Since the characteristic frequency has decreased, and the delay of signal 42 corresponds to a frequency that is relatively lower than the initial characteristic frequency of the interfering signal component, the amplitude or level of the interfering signal component of the processed information signal 46 substantially decreases. As a result, control circuit 66 determines that the amplitude or level of the interfering signal component of processed information signal 75 is now relatively lower than the amplitude or level of the interfering signal component of processed information signals 64 and 84. Control circuit 66 then outputs control signal 32 which effects an increase in the reference time delay created by variable delay line 22 so as to provide a new reference time delay that is equal to the period of the new characteristic frequency of the interfering signal component, and control signals 40 and 48 that vary the delays of variable delay lines 20 and 24, respectively, so that the delay of delay line 20 is relatively greater than the new reference delay and the delay of delay line 24 is relatively less than the new reference delay. Control circuit 66 also outputs signals 62, 74 and 80 that effect shifting of the center frequency Fc of the filters 58, 70 and 78, respectively, to the new characteristic frequency of the interfering signal component.

Thus, amplitude detectors 60, 72 and 82 and control circuit 66 function as a feedback loop that controls the delays of the variable delay lines to constantly produce a reference time delay that is equal to the period of the current characteristic frequency of the interfering signal component. In other words, amplitude detectors 60, 72 and 82 and control circuit 66 automatically vary the reference time delay to match the period of the characteristic frequency of the interfering signal component as this characteristic frequency changes over time.

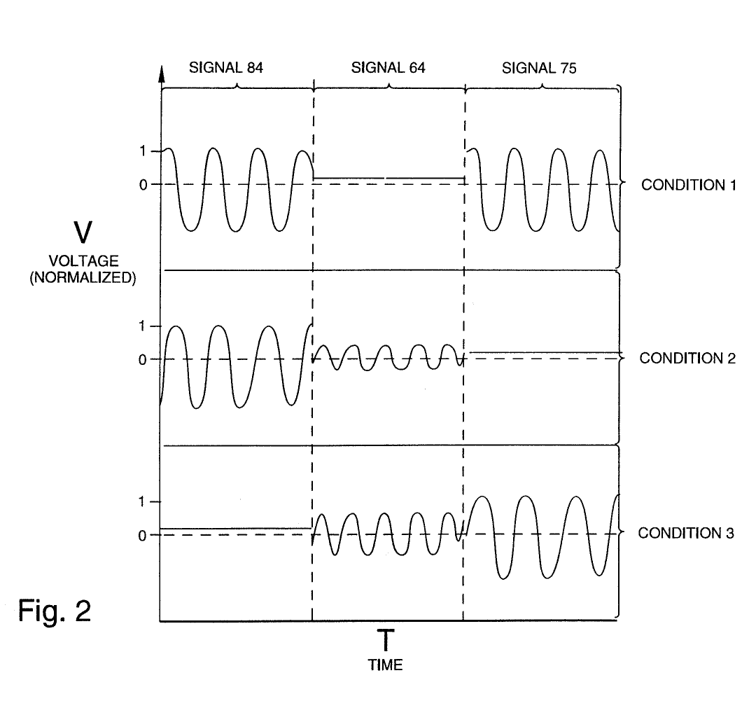

The operation of system 10 is further illustrated by FIG. 2. System 10 is in CONDITION 1, the “tuned” condition, when the characteristic frequency of the interfering signal component corresponds to the reference delay. In CONDITION 1, the amplitude of signal 64 is minimum and the amplitude of signals 75 and 84 are maximum. As the characteristic frequency of the interfering signal component decreases, the period of the interfering signal component increases and approaches the period represented by the delay of delay line 20. As a result, the amplitude of signal 75 decreases and is relatively less than the amplitudes of signals 64 and 84. Such a condition is indicated by CONDITION 2. As the characteristic frequency of the interfering signal increases, the period of the interfering signal component decreases and approaches the period corresponding to the delay of variable delay line 24. As a result, the amplitude of signal 84 is a minimum and is relatively less than the amplitude of signals 64 and 75 and system 10 shifts into CONDITION 3. The amplitude and relative slope of signals 64, 75 and 84 are used to derive the error in: (i) the reference delay, (ii) the delay of delay lines 20, 22 and 24, and (iii) the center frequencies Fc of filters 58, 70 and 78. The relative magnitudes of signals 64, 75 and 84 provide the magnitude and direction of the error signal required to maintain the servo lock and a CONDITION 1 operating status.

The functions of the components of system 10 which were described in the foregoing description can be implemented with commercially available discrete components. For example, RF amplifier 12, signal divider 16, variable delay lines 20, 22 and 24, filters 58, 70 and 78, and detectors 60, 72 and 82 can be realized by discrete components such as NPN or PNP transistors, MOSFETS (metal oxide semiconductor field effect transistors), diodes, PIN diodes and capacitor-inductor networks, etc.

In an alternate embodiment, signal divider 16 is not used and the output of amplifier 12 is connected to the inputs of delay lines 20, 22 and 24.

Alternatively, system 10 can be realized using digital circuitry. In such a configuration, analog-to-digital and digital-to-analog conversions can be accomplished by any suitable chip or chips, e.g. Texas Instruments TLC 32046 A/D/D/A.

Furthermore, some of the functions of the components used in system 10 can be realized by digital signal processing (DSP) circuitry. Examples of suitable digital signal processors are model TMSC5000 manufactured by Texas Instruments™ and model AT73580DSP manufactured by ATMEL™. These are just two examples of suitable digital signal processors. Other suitable commercially available digital processors are manufactured by Hitachi, Intel and Motorola. In one embodiment, control circuit 66 is configured as a microprocessor.

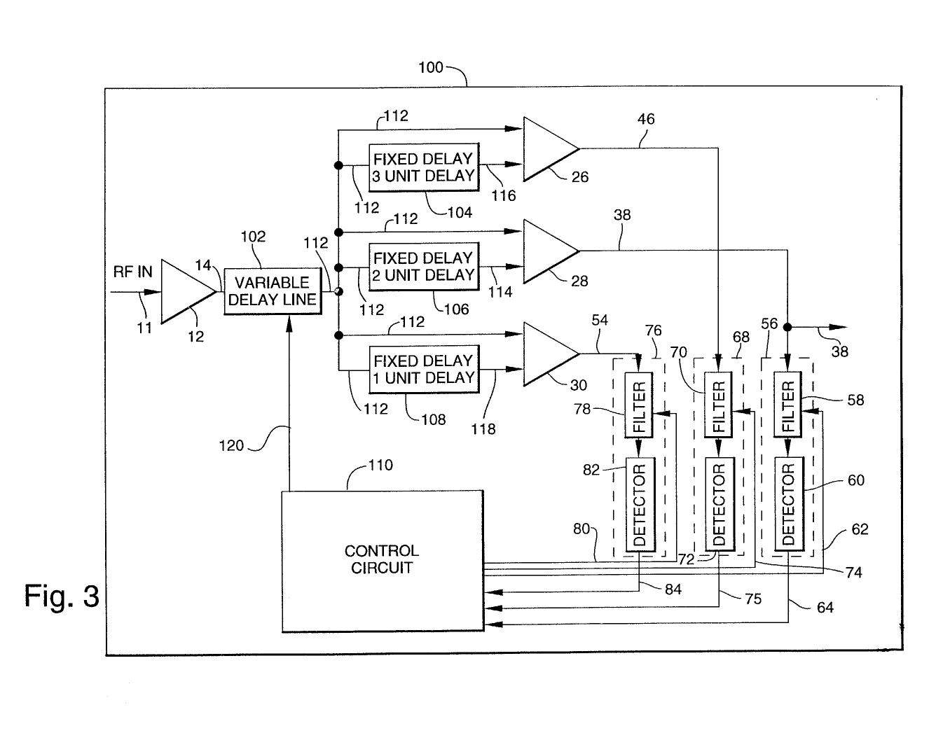

Referring to FIG. 3, there is shown an alternate adaptive electromagnetic interference rejection system 100 of the present invention. System 100 is configured for use with the same RF frequency range with which system 10 is used. System 100 operates in substantially the same manner as system 10. However, variable delay lines 20, 22 and 24 and control circuit 66 of system 10 have been replaced by variable delay line 102, fixed delay lines 104, 106 and 108, and control circuit 110, respectively. RF input signals 11 are inputted into amplifier 12. Amplifier 12 outputs amplified RF signals 14 which are inputted into variable delay line 102. Delay line 102 delays amplified signal 14 by a predetermined delay and outputs delayed signal 112. Delayed signal 112 is inputted into each fixed delay line 104, 106 and 108 and into each differential amplifier 26, 28 and 30 thereby eliminating the need for a power or signal divider, such as power divider 16 shown in FIG. 1. In such a configuration, the delay of each delay line 104, 106 and 108 is fixed. The the initial delay of variable delay line 102 cooperates with the delay of delay line 106 to provide a total delay that corresponds to one wavelength (i.e. the “reference delay”) of the characteristic frequency of the interfering signal component to be cancelled or rejected. Fixed delay line 106 outputs delayed signal 114. Variable delay line 102 cooperates with the delay of delay line 104 to provide a total delay that is greater than one wavelength of the characteristic frequency of the interfering signal component to be cancelled or rejected. Fixed delay line 104 outputs delayed signal 116. Variable delay line 102 cooperates with the delay of delay line 108 to provide a total delay that is less than one wavelength of the characteristic frequency of the interfering signal component to be cancelled or rejected. Fixed delay line 108 outputs delayed signal 118.

Non-delayed signal 112 and delayed signal 116 are inputted into differential amplifier 26. Non-delayed signal 112 and delayed signal 114 are inputted into differential amplifier 28. Non-delayed signal 112 and delayed signal 118 are inputted into differential amplifier 30. Differential amplifiers 26, 28 and 30, and receiving devices 56, 68 and 76 operate in the same manner as described in the foregoing description pertaining to system 10. Control circuit 110 is configured to output a control signal 120 that varies the delay of variable delay line 102 as the characteristic frequency of the interfering signal component to be rejected changes over time. Each fixed delay line 104, 106 and 108 is configured to exhibit a relatively large delay and variable delay line 102 is configured to exhibit a relatively small delay range. Thus, system 100 is suitable when the interfering signal component varies over a relatively small range. System 100 operates in a manner required to maintain the servo lock and a CONDITION 1 operating status as described in the description pertaining to system 10 shown in FIG. 1. In one embodiment, control circuit 110 is configured as a microprocessor.

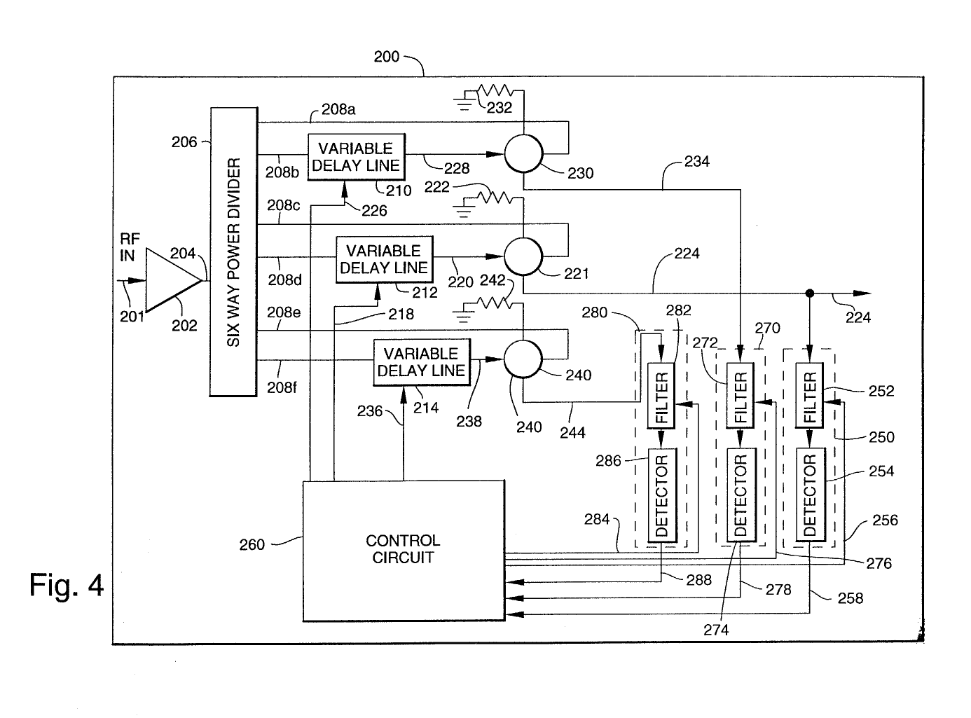

Referring to FIG. 4, there is shown another embodiment of the adaptive electromagnetic interference rejection system of the present invention. System 200 is suitable for RF frequencies which can be implemented using coaxial techniques. RF input signal 201 contains an information signal component and an interfering signal component and is inputted into RF amplifying device 202. RF signal 201 can be provided by an antenna or another RF stage that precedes system 200. Amplifying device 202 may be realized by a commercially available RF amplifier that has sufficient bandwidth. The gain of amplifying device 202 depends upon the application in which system 200 is used. Amplifying device 202 outputs amplified information signal 204 that contains an information component and an interfering signal component. The interfering signal component has a characteristic frequency and an associated period. Amplified information signal 204 is inputted into a six-way power splitter or divider 206. Power splitter or divider 206 outputs signals 208a-f.

Referring to FIG. 4, signals 208b, 208d, and 208f are inputted into variable delay lines 210, 212 and 214, respectively. Signals 208a, 208c and 208e are directly inputted into ring hybrids 230, 221 and 240, respectively. Variable delay line 212 has an input for receiving a control signal 218 and an output for outputting delayed information signal 220. Control signal 218 determines a predetermined reference time delay that is to be exhibited by variable delay line 212. The generation of control signal 218 is discussed in the ensuing description. The predetermined delay is a function of the period associated with the current characteristic frequency of the interfering signal component of information signal 201. This predetermined time delay is referred to herein as the “reference delay”. The reference delay can be any number of periods of the characteristic frequency of the interfering signal component. In one embodiment, the reference delay corresponds to one full period of the interfering signal component that is to be rejected. For purposes of the ensuing description, the reference delay corresponds to one period (i.e. one wavelength or one lambda) of the characteristic frequency of the interfering signal component. The characteristic frequency, as mentioned above, may vary with time but may be treated generally as a constant within the brief delay times associated with a few periods of the interfering signal component.

Variable delay line 212 delays signal 208d by the reference delay so as to produce delayed signal 220. Signals 208c and 220 are inputted into ring hybrid 221. Ring hybrid 221 includes an sum channel output, which is terminated with resistor 222, that provides a signal that represents the sum of signals 208c and 220. Ring hybrid 221 further provides a difference channel output signal 224 that represents the difference between signals 220 and 208c. Signal 224 is referred to herein as a “processed information” signal and is the main system output signal which is inputted into other signal processing devices (not shown).

Variable delay line 210 has an input for receiving control signal 226 and an output for outputting delayed signal 228. Control signal 226 determines a second predetermined delay that is to be exhibited by variable delay line 210. The delay of delay line 210 is relatively greater than the reference delay. The generation of control signal 226 is discussed in the ensuing description. Thus, if the reference delay is one wavelength of the characteristic frequency of the interfering signal component to be suppressed or cancelled, the predetermined second delay is greater than one wavelength. The actual difference between the second predetermined delay and the reference delay remains constant. Non-delayed signals 208a and delayed signal 228 are inputted into ring hybrid 230. Ring hybrid 230 includes a sum channel output, which is terminated with resistor 232, that provides a signal that represents the sum of signals 208a and 228. Ring hybrid 230 further provides a difference channel output signal 234 that represents the difference between signals 228 and 208a. Signal 234 is referred to herein as a “processed information” signal.

Variable delay line 214 has an input for receiving a control signal 236 and an output for outputted delayed signal 238. Control signal 236 controls delay line 214 to exhibit a third predetermined delay that is relatively less than the reference delay. Thus, if the reference delay is one wavelength of the characteristic frequency of the interfering signal component to be suppressed or cancelled, the predetermined third delay is relatively less than one wavelength. The actual difference between the third predetermined delay and the reference delay remains constant. Signals 208e and 238 are inputted into ring hybrid 240. Ring hybrid 240 includes a sum channel output, which is terminated with resistor 242, that provides a signal that represents the sum of signals 208e and 238. Ring hybrid 240 further provides a difference channel output signal 244 that represents the difference between signals 208e and 238. Signal 244 is referred to herein as a “processed information” signal.

The variation of the delays of variable delay lines 210, 212 and 214 is effected by a a “ganged” configuration so that the difference between the second predetermined delay and the reference delay remains constant, the difference between the third predetermined delay and the reference delay remains constant, and the difference between the second predetermined delay and the third predetermined delay remains constant.

As described in the foregoing description, information signal 208c (also referred to herein as the “non-delayed information signal”) and delayed information signal 220 are inputted into ring hybrid 221 which subtracts the level of the delayed information signal 220 from that of the non-delayed information signal 208c to form a processed information signal 224 in which the level of the information component is substantial and the level of the interfering signal component is negligible. The effect of the foregoing processing is to cancel the interfering signal component of the information signal while substantially maintaining the information portion outputted by amplifier 202. Processed information signal 224 is outputted via a main system output for use with other signal processing components (not shown). Signal 224 is also inputted into receiving circuit 250. In one embodiment, receiving circuit 250 comprises a tuned filter 252 and an amplitude detector 254. In one embodiment, filter 252 is a variable band pass filter having a variable center frequency Fc. In a preferred embodiment, center frequency Fc is varied by control signal 256. This feature is discussed in detail in the ensuing description. The center frequency Fc is equal to the current characteristic frequency of the interfering signal component of information signal 201. Filter 252 removes the information component from the processed information signal 224 and outputs any remaining interfering signal component. The output of filter 252 is then inputted into amplitude detector 254. Amplitude detector 254 outputs a signal 258 that represents the amplitude or level of the interfering signal component outputted by filter 252. Signal 258 is then inputted into control circuit 260. The purpose of this configuration is discussed in detail in the ensuing description.

As described in the foregoing description, variable delay circuit 210 outputs delayed information signal 228. Delayed information signal 228 is inputted into ring hybrid 230 which subtracts the level of delayed information signal 228 from that of non-delayed digital information signal 208a to form processed information signal 234. Since the delay of delayed information signal 228 is greater than the reference delay, the delay of signal 228 is not associated with the period of the current characteristic frequency of the interfering signal component, but rather, is associated with a relatively lower frequency. Thus, the amplitude or level of the interfering signal component of processed information signal 234 is substantially higher than the amplitude or level of the interfering signal component of processed information signal 224.

Signal 234 is inputted into receiving circuit 270. In one embodiment, receiving circuit 270 comprises a tuned filter 272 and an amplitude detector circuit 274. In one embodiment, filter 270 is a variable band pass filter having a variable center frequency Fc. In a preferred embodiment, center frequency Fc can be varied by control signal 276. The generation of control signal 276 is discussed in detail in the ensuing description. The center frequency Fc is equal to the current characteristic frequency of the interfering signal component of information signal 234. Filter 272 removes the information component from the processed information signal 234 and outputs any remaining interfering signal component. The output of filter 272 is then inputted into amplitude detector 274. Amplitude detector 274 outputs signal 278 that represents the amplitude or level of the interfering signal component outputted by filter 272. Signal 278 is then inputted into control circuit 260. The purpose of this configuration is discussed in detail in the ensuing description.

As described in the foregoing description, variable delay line 214 outputs delayed information signal 238. The delay of information signal 238 is relatively less than the reference delay of information signal 220 and corresponds to a frequency that is relatively higher than the characteristic frequency of the interfering signal component. Delayed information signal 238 is inputted into ring hybrid 240 that subtracts the level of delayed information signal 238 from that of non-delayed information signal 208e to form processed information signal 244. Therefore, the amplitude or level of the interfering signal component of processed signal 244 is substantially higher than the amplitude or level of the interfering signal component of processed information signal 224. Processed information signal 244 is then inputted into receiver circuit 280. Receiver circuit 280 comprises tuned filter 282. In one embodiment, filter 282 is configured as variable band pass filter as described in the foregoing description. Filter 282 has a center frequency Fc that is equal to the current frequency of the interfering signal component of information signal 201. The center frequency Fc can be varied by control signal 284. Filter 282 filters processed information signal 244 so as to remove the information component and pass only the interfering signal component. Receiver circuit 280 further includes amplitude detector circuit 286 which receives the filtered signal outputted by filter 282. Amplitude detector circuit 286 outputs signal 288 that represents the amplitude or level of the interfering signal component of the signal outputted by filter 282. The purpose of this configuration will be discussed in detail in the ensuing description. It is to be understood that filter 282 can be configured as a variable low pass filter or variable high pass filter.

Control circuit 260 receives signals 258, 278 and 288 outputted by amplitude detectors 254, 274 and 286, respectively. Control circuit 260 contains circuitry that effects comparison of the amplitudes represented by signals 258, 278 and 288 to determine whether the amplitude represented by signal 258 is relatively lower than the amplitude represented by signal 278 and the amplitude represented by signal 288. If control circuit 260 determines that the amplitude represented by signal 258 is lower than the amplitudes represented by signals 278 and 288, then control circuit 260 outputs control signals 218, 226 and 236 that are inputted into variable delay lines 212, 210 and 214, respectively, so as to maintain the current reference time delay. Control signals 256, 276 and 284 are also inputted into filters 252, 272 and 282, respectively, to maintain the current center frequency Fc of the pass band of the filters.

In a preferred embodiment, filters 252, 272 and 282 are all the same type of filter, i.e. all band pass filters, all high pass filter, all low pass filters, etc. In a preferred embodiment, the tuning of filters 252, 272 and 282 are configured in a “ganged” configuration so that the center frequency Fc of the band passes of all filters can be varied simultaneously. In a preferred embodiment, the tuning of filters 252, 272 and 282 occurs simultaneously with the adjustment of the delays of delay lines 210, 212, and 214.

If the characteristic frequency of the interfering signal component of information signal 201 increases or decreases, the current reference delay will not be equal to the period of the new characteristic frequency of the interfering signal component. Therefore, there will be minimum or no cancellation of the interfering signal component in ring hybrid 221. As a result, the amplitude or level of the interfering signal component of processed information signal 224 increases significantly.

System 200 implements an initialization process in order to determine the initial reference time delay because the characteristic frequency of the interfering signal component of information signal 201 is not initially known. When system 200 is activated, RF signals 201 are inputted into RF amplifier 202 and control circuit 260 outputs a sequence of control signals 218, 226 and 236 that control variable delay lines 212, 210 and 214, respectively, to increase the reference delay in graduations starting from an initial reference time delay to a maximum reference time delay. As control circuit 260 sweeps through this range of time delays, control circuit 260 simultaneously outputs a corresponding sequence of control signals 256, 276 and 284 to vary the center frequency Fc of the band pass of each filters 252, 272, and 282, respectively, until the center frequency Fc corresponds to the period represented by the reference delay. As the delays of the delay lines and center frequency Fc are varied, control circuit 260 monitors the amplitudes represented by signals 258, 278 and 288. Specifically, control circuit 260 stores in memory the particular reference time delays that cause the amplitude or level represented by signal 258 to be relatively lower than the amplitudes represented by the signals 278 and 288. Normal operation of system 200 can begin once control circuit 260 completely sweeps the range of possible reference time delays and stores the relevant reference time delays in memory.

As the characteristic frequency of the interfering signal component of information signal 201 increases, the reference time delay of delay line 212 is no longer equal to the period of the characteristic frequency of interfering signal component. As a result, the amplitude of the interfering signal component of processed information signal 224 substantially increases because there is now only minimal cancellation of the interfering signal component. Since the characteristic frequency of the interfering signal component has increased, and the delay of signal 238 corresponds to a frequency that is relatively higher than the initial characteristic frequency of the interfering signal component, the amplitude or level of the interfering signal component of the processed information signal 244 substantially decreases. Subsequently, control circuit 260 now determines that the amplitude or level of the interfering signal component of processed information signal 288 is now relatively lower than the amplitudes or levels of the interfering signal component of processed information signals 258 and 278 Control circuit 260 then outputs control signal 218 which effects a decrease in the reference time delay created by variable delay line 212 so as to provide a new reference time delay that is equal to the period of the new characteristic frequency of the interfering signal component. Control circuit 260 also outputs control signals 226 and 236 that vary the delays of variable delay lines 210 and 214, respectively, so that the delay created by delay line 210 is relatively greater than the new reference delay and the delay of delay line 214 is relatively less than the new reference delay. Control signal 260 also shifts the center frequency Fc of the band pass of each filter 252, 272, and 282 via control signals 258, 278 and 288, respectively, to the new characteristic frequency of the interfering signal component.

As the characteristic frequency of the interfering signal component of information signal 201 decreases, the reference time delay is no longer equal to the period of the characteristic frequency of interfering signal component. As a result, the amplitude of the interfering signal component of processed information signal 224 substantially increases because there is now only minimal cancellation of the interfering signal component. Since the characteristic frequency of the interfering signal component has decreased, and the delay of signal 228 corresponds to a frequency that is relatively lower than the initial characteristic frequency of the interfering signal component, the amplitude or level of the interfering signal component of the processed information signal 234 substantially decreases. As a result, control circuit 260 determines that the amplitude or level represented by signal 278 is now relatively lower than the amplitude or level represented by signals 258 and 288. Control circuit 260 then outputs control signal 218 which effects an increase in the reference delay created by variable delay line 212 so as to provide a new reference time delay that is equal to the period of the new characteristic frequency of the interfering signal component, and signals 226 and 236 that vary the delays of variable delay lines 210 and 236, respectively, so that the delay of delay line 210 is relatively greater than the new reference delay and the delay of delay line 214 is relatively less than the new reference delay. Control circuit 260 also outputs signals 256, 276 and 284 that effect shifting of the center frequency Fc of the filters 252, 272 and 282, respectively, to the new characteristic frequency of the interfering signal component.

Thus, amplitude detectors 254, 274 and 286 and control circuit 260 function as part of a feedback loop that controls the delays of the variable delay lines to constantly produce a reference time delay that is equal to the period of the current characteristic frequency of the interfering signal component. In other words, amplitude detectors 254, 274 and 286 and control circuit 260 function as part as a feedback loop that automatically varies the reference time delay to match the period of the characteristic frequency of the interfering signal component as this characteristic frequency changes over time. System 200 functions in the same manner as systems 10 and 100 in that the relative magnitudes of signals 258, 278 and 288 provide the magnitude and direction of the error signal required to maintain servo lock and an operating condition, which is similar to the CONDITION 1 operating status described in the foregoing description, wherein the magnitude or level of signal 258 is less than the magnitude or level of signals 278 and 288. In one embodiment, control circuit 260 is configured as a microprocessor.

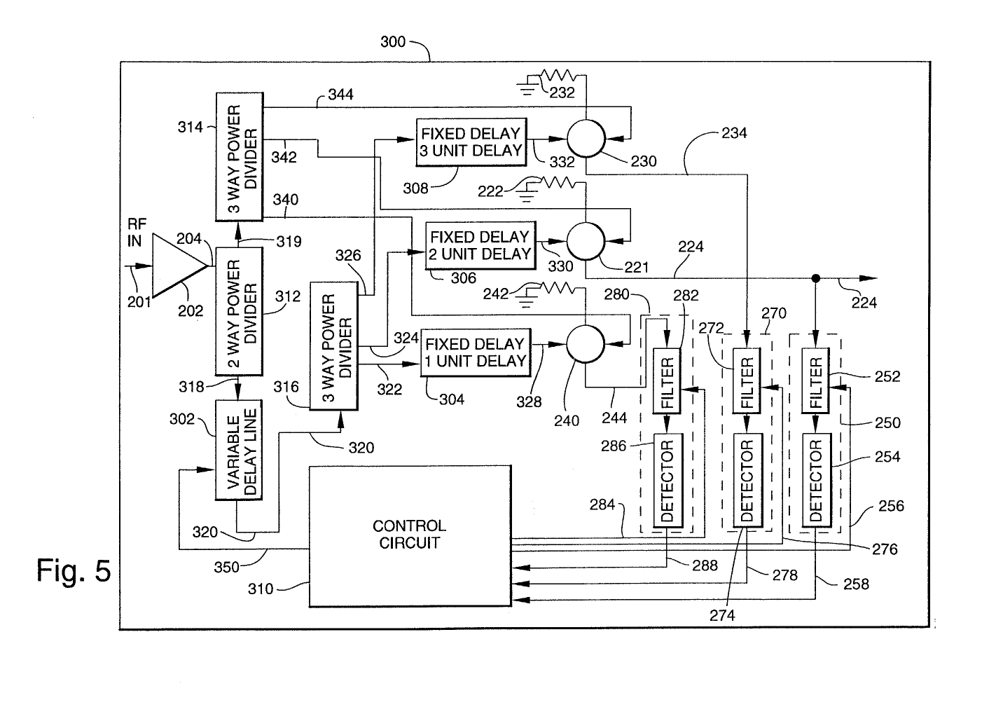

Referring to FIG. 5, there is shown an alternate embodiment of system 200. System 300 is configured for use with the same RF frequency range with which system 200 is used. System 300 operates in substantially the same manner as system 200. However, variable delay lines 210, 212 and 214 and control circuit 260 of system 200 have been replaced by variable delay line 302, fixed delay lines 304, 306 and 308, and control circuit 310, respectively. Furthermore, power or signal divider 206, shown in FIG. 4, is replaced by two-way power divider 312, three-way power divider 314, and three-way power divider 316. RF input signals 201 are inputted into amplifier 202. Amplifier 202 outputs amplified RF signals 204 which are inputted into power divider 312. Power divider 312 outputs signals 318 and 319. Signal 318 is inputted into variable delay line 302. Delay line 302 delays signal 318 by a predetermined delay and outputs delayed signal 320. Delayed signal 320 is inputted into power divider 316. Power divider 316 divides signal 320 into signals 322, 324 and 326. Signals 322, 324 and 326 are inputted into fixed delay lines 304, 306 and 308, respectively. Fixed delay lines 304, 306 and 308 output delayed signals 328, 330 and 332, respectively. Delayed signals 328, 330 and 332 are inputted into ring hybrids 240, 221 and 230, respectively.

Signal 319 is inputted into power divider 314. Power divider 314 divides signal 319 into signals 340, 342 and 344. Signals 340, 342 and 344 are inputted directly into ring hybrids 240, 221 and 230, respectively. The delay of each delay line 304, 306 and 308 is fixed. The delay of variable delay line 302 cooperates with the delay of delay line 306 to provide a total delay that corresponds to one wavelength (i.e. the “reference delay”) of the characteristic frequency of the interfering signal component to be cancelled or rejected. Fixed delay line 306 outputs delayed signal 330. Variable delay line 302 cooperates with the delay of delay line 304 to provide a total delay that is relatively less than one wavelength of the characteristic frequency of the interfering signal component to be cancelled or rejected. Delay line 304 outputs delayed signal 328. Variable delay line 302 cooperates with the delay of delay line 308 to provide a total delay that is relatively greater than one wavelength of the characteristic frequency of the interfering signal component to be cancelled or rejected. Fixed delay line 308 outputs delayed signal 332. Non-delayed signal 344 and delayed signal 332 are inputted into ring hybrid 230. Non-delayed signal 342 and delayed signal 330 are inputted into ring hybrid 221. Non-delayed signal 340 and delayed signal 328 are inputted into ring hybrid 240. Ring hybrids 221, 230 and 240, and receiving devices 250, 270 and 280 operate in the same manner as described in the foregoing description. Control circuit 310 is configured to output control signal 350 that varies the delay of variable delay line 302 so as to track the characteristic frequency of the interfering signal component to be rejected. Each fixed delay line 304, 306 and 308 is configured to exhibit a relatively large delay and variable delay line 302 is configured to exhibit a relatively small delay range. Thus, system 300 is suitable when characteristic frequency of the interfering signal component varies over a relatively small range. System 300 operates in a manner required to maintain the servo lock and an operational condition, similar to the CONDITION 1 operating status described in the foregoing description, wherein the amplitude of signal 258 is maintained to be relatively less than the amplitudes or levels of signals 278 and 288.

In one embodiment, control circuit 310 is configured as a microprocessor.

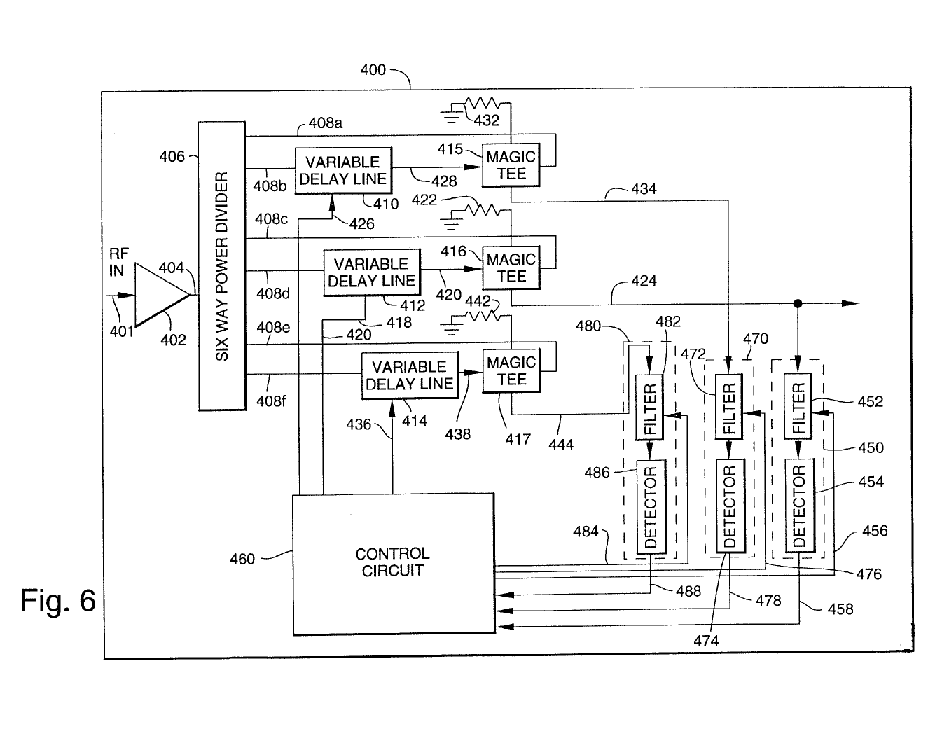

Referring to FIG. 6, there is shown another embodiment of the adaptive electromagnetic interference rejection system of the present invention. System 400 is suitable for use with microwave frequencies. Microwave signal 401 contains an information signal component and an interfering microwave electromagnetic component (referred to herein as the “interfering signal component” or “interfering component”) and is inputted into amplifying device 402 which amplifies signals 401. Signals 401 can be provided by an antenna, waveguide or any other microwave system the precedes system 400. Amplifying device 402 may be realized by a commercially available microwave amplifier that has sufficient bandwidth. The gain of amplifying device 402 depends upon the application in which system 400 is used. Amplifying device 402 outputs amplified information signal 404 that contains an information component and an interfering signal component. The interfering signal component has a characteristic frequency and an associated period. Amplified information signal 404 is inputted into a six-way power splitter or divider 406. Power splitter or divider 406 outputs signals 408a-f.

Signals 408b, 408d, and 408f are inputted into variable delay lines 410, 412 and 414, respectively. Signals 408a, 408c and 408e are directly inputted into magic “T” devices 415, 416 and 417, respectively. Variable delay line 412 has an input for receiving a control signal 418 and an output for outputting delayed information signal 420. Control signal 418 determines a predetermined reference time delay that is to be exhibited by variable delay line 412. The generation of control signal 418 is discussed in the ensuing description. The predetermined delay is a function of the period associated with the current characteristic frequency of the interfering signal component of information signal 401. This predetermined time delay is referred to herein as the “reference delay”. The reference delay can be any number of periods of the characteristic frequency of the interfering signal component. In one embodiment, the reference delay corresponds to one full period of the interfering signal component that is to be rejected. For purposes of the ensuing description, the reference delay will correspond to one period (i.e. one wavelength or one lambda) of the characteristic frequency of the interfering signal component. The characteristic frequency, as mentioned above, may vary with time but may be treated generally as a constant within the brief delay times associated with a few periods of the interfering signal component.

Variable delay line 412 delays signal 408d by the reference delay so as to produce delayed signal 420. Signals 408c and 420 are inputted into magic “T” device 416. Magic “T” device 416 includes a sum channel output, which is terminated with resistor 422, that provides a signal that represents the sum of signals 408c and 420. Magic “T” device 416 further provides a difference channel output signal 424 that represents the difference between signals 420 and 408c. Signal 424 is referred to herein as a “processed information” signal and is the main system output signal which is inputted into other signal processing devices (not shown).

Variable delay line 410 has an input for receiving control signal 426 and an output for outputting delayed signal 428. Control signal 426 determines a second predetermined delay that is to be exhibited by variable delay line 410. The second predetermined delay is relatively greater than the reference delay. The generation of control signal 426 is discussed in the ensuing description. Thus, if the reference delay is one wavelength of the characteristic frequency of the interfering signal component to be suppressed or cancelled, the predetermined second delay is greater than one wavelength. The actual difference between the second predetermined delay and the reference delay remains constant. Non-delayed signals 408a and delayed signal 428 are inputted into magic “T” device 415. Magic “T” device 415 includes a sum channel output that is terminated with resistor 432 and provides a signal that represents the sum of signals 408a and 428. Magic “T” device 415 further provides a difference channel output signal 434 that represents the difference between signals 428 and 408a. Signal 434 is referred to herein as a “processed information” signal.

Variable delay line 414 has an input for receiving a control signal 436 and an output for outputted delayed signal 438. Control signal 436 controls delay line 414 to exhibit a third predetermined delay that is relatively less than the reference delay. Thus, if the reference delay is one wavelength of the characteristic frequency of the interfering signal component to be suppressed or cancelled, the predetermined third delay is relatively less than one wavelength. Thus, signal 408f is delayed by a delay that is less than the reference delay. The actual difference between the third predetermined delay and the reference delay remains constant. Signals 408e and 438 are inputted into magic “T” device 417. Magic “T” device 417 includes a sum channel output that is terminated with resistor 442 and provides a signal that represents the sum of signals 408e and 438. Magic “T” device 417 further provides a difference channel output signal 444 that represents the difference between signals 408e and 438. Signal 444 is referred to herein as a “processed information” signal.

The variation of the delays of variable delay lines 410, 412 and 414 is implemented in a “ganged” configuration so that the difference between the second predetermined delay and the reference delay remains constant, the difference between the third predetermined delay and the reference delay remains constant, and the difference between the second predetermined delay and the third predetermined delay remains constant.

As described in the foregoing description, information signal 408c (also referred to herein as “non-delayed information signal”) and delayed information signal 420 are inputted into magic “T” device 416 which subtracts the level of the delayed information signal 420 from that of the non-delayed information signal 408c to form a processed information signal 424 in which the level of the information component is substantial and the level of the interfering signal component is negligible. The effect of the foregoing processing is to cancel the interfering signal component of the information signal while substantially maintaining the information portion of signal 404 that is outputted by amplifier 402. Processed information signal 424 is outputted via a main system output for use with other external signal processing components (not shown). Signal 424 is also inputted into receiving circuit 450. In one embodiment, receiving circuit 450 comprises a tuned filter 452 and an amplitude detector circuit 454. In one embodiment, filter 452 is a variable band pass filter having a variable center frequency Fc. In a preferred embodiment, center frequency Fc is varied by control signal 456. This feature is discussed in detail in the ensuing description. The center frequency Fc is equal to the current characteristic frequency of the interfering signal component of information signal 401. Filter 452 removes the information component from the processed information signal 424 and outputs any remaining interfering signal component. The output of filter 452 is then inputted into amplitude detector 454. Amplitude detector 454 outputs a signal 458 that represents the amplitude or level of the interfering signal component outputted by filter 452. Signal 458 is then inputted into control circuit 460. The purpose of this configuration is discussed in detail in the ensuing description.

As described in the foregoing description, variable delay circuit 410 outputs delayed information signal 428. Delayed information signal 428 is inputted into magic “T” device 415 which subtracts the level of delayed information signal 428 from that of non-delayed digital information signal 408a to form processed information signal 434. Since the delay of delayed information signal 428 is greater than the reference delay, the delay of signal 428 is not associated with the period of the current characteristic frequency of the interfering signal component, but rather, is associated with a relatively lower frequency. Thus, the amplitude or level of the interfering signal component of processed information signal 434 is substantially higher than the amplitude or level of the interfering signal component of processed information signal 424. Signal 434 is inputted into receiving circuit 470. In one embodiment, receiving circuit 470 comprises a tuned filter 472 and an amplitude detector circuit 474. In one embodiment, filter 470 is a variable band pass filter having a variable center frequency Fc. In a preferred embodiment, center frequency Fc is varied by control signal 476. The generation of control signal 476 is discussed in detail in the ensuing description. The center frequency Fc is the current characteristic frequency of the interfering signal component of information signal 404. Filter 472 removes the information component from the processed information signal 434 and outputs any remaining interfering signal component. The output of filter circuit 472 is then inputted into amplitude detector 474. Amplitude detector 474 outputs signal 478 that represents the amplitude or level of the interfering signal component outputted by filter 472. Signal 478 is then inputted into control circuit 460. The purpose of this configuration is discussed in detail in the ensuing description.

As described in the foregoing description, variable delay line 414 outputs delayed information signal 438. The delay of information signal 438 is relatively less than the reference delay of information signal 420 and corresponds to a frequency that is relatively higher than the characteristic frequency of the interfering signal component. Delayed information signal 438 is inputted into magic “T” device 417 which subtracts the level of delayed information signal 438 from that of non-delayed information signal 408e to form processed information signal 444. Since the delay of information signal 438 is relatively less than the reference delay of information signal 420, this delay corresponds to a frequency that is relatively higher than the characteristic frequency of the microwave interfering signal component. Therefore, the amplitude or level of the interfering signal component of processed signal 444 is substantially higher than the amplitude or level of the interfering signal component of processed information signal 424. Processed information signal 444 is then inputted into receiver circuit 480. In one embodiment, receiver circuit 480 comprises tuned filter 482. In one embodiment, filter 482 is configured as variable band pass filter as described in the foregoing description. Filter 482 has a center frequency Fc that is equal to the current frequency of the interfering signal component of information signal 401. The center frequency Fc is varied by control signal 484. Filter 482 filters processed information signal 444 so as to remove the information component and pass only the interfering signal component. Receiver circuit 480 further includes amplitude detector circuit 486 which receives the filtered signal outputted by filter 482. Amplitude detector circuit 486 outputs signal 488 that represents the amplitude or level of the interfering signal component of the signal outputted by filter 482. The purpose of this configuration will be discussed in detail in the ensuing description.

Control circuit 460 receives signals 458, 478 and 488 outputted by amplitude detector circuits 454, 474 and 486, respectively. Control circuit 460 contains circuitry that effects comparison of the amplitudes represented by signals 458, 478 and 488 to determine whether the amplitude represented by signal 458 is relatively lower than the amplitude represented by signal 478 and the amplitude represented by signal 488. If control circuit 460 determines that the amplitude represented by signal 458 is lower than the amplitudes represented by signals 478 and 488, then control circuit 460 outputs control signals 420, 426 and 436 that are inputted into variable delay lines 412, 410 and 414, respectively, so as to maintain the current reference time delay. Control signals 456, 476 and 484 are also inputted into filters 452, 472 and 482, respectively, to maintain the current center frequency Fc of the pass band of the filters.

In a preferred embodiment, filters 452, 472 and 482 are all the same type of filter, i.e. all band pass filters, all high pass filter, all low pass filters, etc. In a preferred embodiment, filters 452, 472 and 482 are configured in a “ganged” configuration so that the center frequencies Fc of the filters are varied simultaneously. In a preferred embodiment, the tuning of filters 452, 472 and 482 occurs simultaneously with the adjustment of the delays of delay lines 410, 412, and 414.

If the characteristic frequency of the interfering signal component of information signal 401 increases or decreases, the current reference delay will not be equal to the period of the new characteristic frequency of the interfering signal component. Therefore, there will be minimum or no cancellation of the interfering signal component in magic “T” device 416. As a result, the amplitude or level of the microwave interfering signal component of processed information signal 424 increases significantly.

System 400 implements an initialization process in order to determine the initial reference time delay because the characteristic frequency of the interfering signal component of information signal 401 is not initially known. When system 400 is activated, microwave signals 401 are inputted into amplifier 402 and control circuit 460 outputs a sequence of control signals 418, 426 and 436 that control variable delay lines 410, 412 and 414, respectively, to increase the reference delay in graduations starting from an initial reference time delay to a maximum reference time delay. As control circuit 460 sweeps through this range of time delays, control circuit 460 simultaneously outputs a corresponding sequence of control signals 456, 476 and 484 to vary the center frequency Fc of the band pass of each filters 452, 472, and 482, respectively, so that the center frequency Fc is equal to a frequency that corresponds to the period represented by the reference delay. As the delays of the delay lines and center frequency Fc are varied, control circuit 460 monitors the amplitudes represented by signals 458, 478 and 488. Specifically, control circuit 460 stores in memory the particular reference time delays that cause the amplitude or level represented by signal 458 to be relatively lower than the amplitudes represented by the signals 478 and 488. Normal operation of system 400 can begin once control circuit 460 completely sweeps the range of possible reference time delays and stores the relevant reference time delays in memory.

As the characteristic frequency of the interfering signal component of signal 401 increases, the reference time delay of delay line 412 is no longer equal to the period of the characteristic frequency of the interfering signal component. As a result, the amplitude of the interfering signal component of processed information signal 424 substantially increases because there is now only minimal cancellation of the interfering signal component. Since the characteristic frequency of the interfering signal component has increased, and the delay of signal 438 corresponds to a frequency that is relatively higher than the initial characteristic frequency of the interfering signal component, the amplitude or level of the interfering signal component of the processed information signal 444 substantially decreases. Subsequently, control circuit 460 now determines that the amplitude or level of signal 488 is now relatively lower than the amplitudes or levels of signals 458 and 478. Control circuit 460 then outputs signal 418 which effects a decrease in the reference time delay created by variable delay line 412 so as to provide a new reference time delay that is equal to the period of the new characteristic frequency of the interfering signal component. Control circuit 460 also outputs control signals 426 and 436 that vary the delays of variable delay lines 410 and 414, respectively, so that the delay created by delay line 410 is greater than the new reference delay and the delay of delay line 414 is relatively less than the new reference delay. Control signal 460 also shifts the center frequency Fc of the band pass of each filter 452, 472 and 482, via control signals, 456, 476 and 484, respectively, to the new characteristic frequency of the interfering signal component.

As the characteristic frequency of the interfering signal component of information signal 401 decreases, the reference time delay is no longer equal to the period of the characteristic frequency of interfering signal component. As a result, the amplitude of the interfering signal component of processed information signal 424 substantially increases because there is now only minimal cancellation of the interfering signal component. Since the characteristic frequency of the interfering signal component has decreased, and the delay of signal 428 corresponds to a frequency that is relatively lower than the initial characteristic frequency of the interfering signal component, the amplitude or level of the interfering signal component of the processed information signal 434 substantially decreases. As a result, control circuit 460 determines that the amplitude or level of signal 478 is now relatively lower than the amplitude or level of signals 458 and 488. Control circuit 460 then outputs signal 418 which effects an increase in the reference time delay created by variable delay line 412 so as to provide a new reference time delay that is equal to the period of the new characteristic frequency of the interfering signal component. Control circuit 460 also outputs signals 426 and 436 that vary the delays of delay lines 410 and 414, respectively, so that the delay of delay line 410 is greater than the new reference delay and the delay of delay line 414 is relatively less than the new reference delay. Control circuit 460 also outputs signals 456, 476 and 484 that effect shifting of the center frequency Fc of the filters 452, 472 and 482, respectively, to the new characteristic frequency of the interfering signal component.

Thus, amplitude detectors 454, 474 and 486 and control circuit 460 function as part of a feedback loop that controls the delays of the variable delay lines 410, 412 and 414 to constantly produce a reference time delay that is equal to the period of the current characteristic frequency of the interfering signal component. In other words, amplitude detectors 454, 474 and 486 and control circuit 460 function as part of a feedback loop that automatically varies the reference time delay to match the period of the characteristic frequency of the interfering signal component as this characteristic frequency changes over time. System 400 functions in the same manner as systems 10, 100, 200 and 300 in that the relative magnitudes of signals 458, 478 and 488 provide the magnitude and direction of the error signal required to maintain servo lock and an operating condition, which is similar to the CONDITION 1 operating status described in the foregoing description, wherein the amplitude of signal 458 is maintained so as to be less than the amplitudes of signals 478 and 488. In one embodiment, control circuit 460 is configured as a microprocessor.

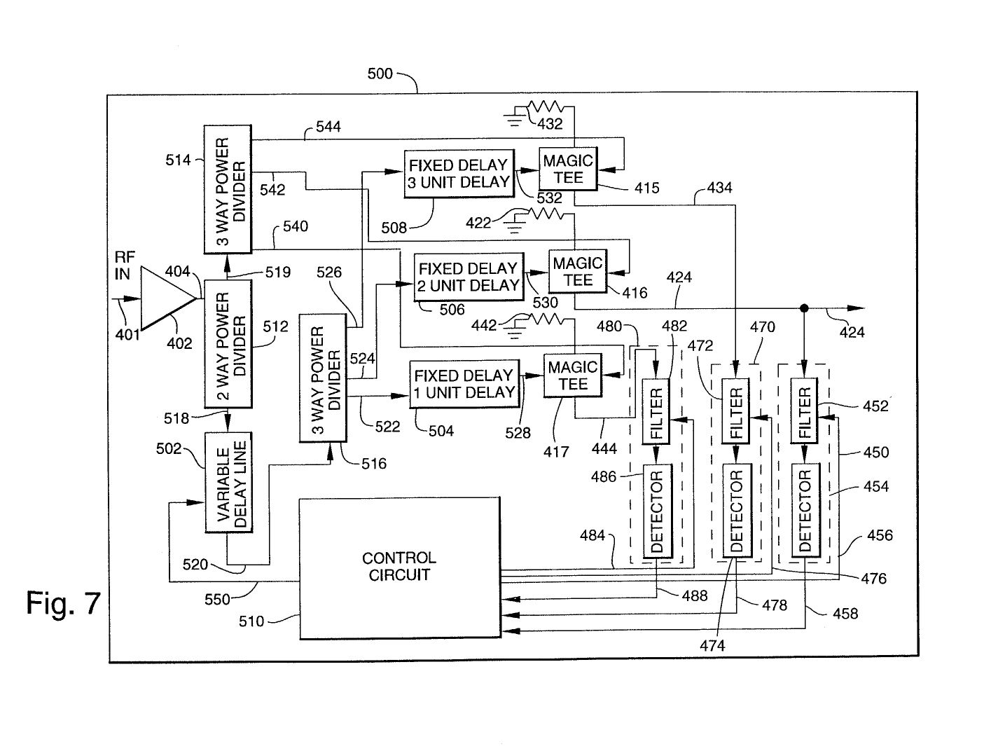

Referring to FIG. 7, there is shown an alternate embodiment of system 400. System 500 is configured for use with the same microwave frequency range with which system 400 is used. System 500 operates in substantially the same manner as system 500. However, variable delay lines 410, 412 and 414 and control circuit 460 of system 400 have been replaced by variable delay line 502, fixed delay lines 504, 506 and 508, and control circuit 510, respectively. Furthermore, power or signal divider 406, shown in FIG. 6, is replaced by two-way power divider 512, three-way power divider 514, and three-way divider 516. Microwave signals 401 are inputted into amplifier 402. Amplifier 402 outputs amplified microwave signals 404 which are inputted into power divider 512. Power divider 512 outputs signals 518 and 519. Signal 518 is inputted into variable delay line 502. Delay line 502 delays signal 518 by a predetermined delay and outputs delayed signal 520. Delayed signal 520 is inputted into power divider 516. Power divider 516 divides signal 520 into signals 522, 524 and 526. Signals 522, 524 and 526 are inputted into fixed delay lines 504, 506 and 508, respectively. Fixed delay lines 504, 506 and 508 output delayed signals 528, 530 and 532, respectively. Delayed signals 528, 530 and 532 are inputted into magic “T” devices 417, 416 and 415, respectively.

Signal 519 is inputted into power divider 514. Power divider 514 divides signal 519 into signals 540, 542 and 544. Signals 540, 542 and 544 are inputted directly into magic “T” devices 417, 416 and 415, respectively. The delay of each delay line 504, 506 and 508 is fixed. In one embodiment, the delay of variable delay line 502 cooperates with the delay of delay line 506 to provide a total delay that corresponds to one wavelength (i.e. the “reference delay”) of the characteristic frequency of the interfering signal component to be cancelled or rejected. Fixed delay line 506 outputs delayed signal 530. Variable delay line 502 cooperates with the delay of delay line 508 to provide a total delay that is greater than one wavelength of the characteristic frequency of the interfering signal component to be cancelled or rejected. Variable delay line 508 outputs delayed signal 532. Variable delay line 502 cooperates with the delay of delay line 504 to provide a total delay that is less than one wavelength of the characteristic frequency of the interfering signal component to be cancelled or rejected. Fixed delay line 504 outputs delayed signal 528.

Non-delayed signal 544 and delayed signal 532 are inputted into magic “T” device 415. Non-delayed signal 542 and delayed signal 530 are inputted into magic “T” device 416. Non-delayed signal 540 and delayed signal 528 are inputted into magic “T” device 417. Magic “T” devices 415, 416, and 417 and receiving devices 450, 470 and 480 operate in the same manner as described in the foregoing description pertaining to system 400. Control circuit 510 is configured to output control signal 550 that varies the delay of variable delay line 502 so as to track the characteristic frequency of the interfering signal component to be rejected. Each fixed delay line 504, 506 and 508 is configured to exhibit a relatively large delay and variable delay line 502 is configured to operate over a relatively small delay range. Thus, system 500 is suitable when the characteristic frequency of the interfering signal component varies over a relatively small range. System 500 operates in a manner required to maintain the servo lock and an operating condition, which is substantially the same as the CONDITION 1 operating condition status described in the foregoing description, wherein the amplitude of signal 458 is maintained so as to be less than the amplitudes of signals 478 and 488.

The adaptive electromagnetic interference rejection system and method of the present invention improves upon the phase alignment difficulties inherent in prior art RF electromagnetic interference rejection systems that mathematically manipulate an interfering signal with an information signal. With such prior art systems, it is difficult to establish a reference by which to precisely control the phase relationship between the signals. In the present invention as described above, the interfering signal component is not mathematically manipulated with an information signal. Rather, the interfering signal component is used to determine the precise reference time delay to apply to the information signal for forming a delayed information signal relative to the non-delayed information signal. Once the reference time delay is determined, the precisely delayed information signal is mathematically manipulated with the non-delayed information signal to cancel the interfering signal component therein without the phase alignment difficulties inherent in the prior art interference rejection systems.

The principals, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations in changes may be made by those skilled in the art without departing from the spirit of the invention. Accordingly, the foregoing detailed description should be considered exemplary in nature and not limited to the scope and spirit of the invention as set forth in the attached claims.

What is claimed is:

1. A method of rejecting a radio frequency (RF) interfering signal introduced into an information signal, comprising the steps of:
a) receiving an RF signal having an information component and an interfering signal component having a varying characteristic frequency;
b) delaying the RF signal by a reference delay time that is equal to a predetermined number of periods of the characteristic frequency to form a delayed RF signal;
c) processing the RF signal and the delayed RF signal to form a processed reference RF signal in which the information component is substantial and the interfering signal component is negligible;
d) determining the amplitude of the interfering signal component of the processed reference RF signal; and
e) varying the delay of the RF signal as the characteristic frequency of the interfering signal component changes in order to maintain the interfering signal component of the processed reference RF signal at a minimum level.

2. The method according to claim 1 wherein the delaying step (b) further comprises simultaneously providing (i) a second delayed RF signal that is delayed, with respect to the RF signal, by an amount of time that is less than the reference delay time, and (ii) a third delayed RF signal that is delayed, with respect to the RF signal, by an amount of time that is greater than the reference delay time.

3. The method according to claim 3 wherein processing step (c) further comprises the steps of:
processing the second delayed RF signal with the received RF signal to provide a second processed signal; and
processing the third delayed RF signal with the received RF signal to provide a third processed signal.

4. The method according to claim 3 wherein varying step (e) comprising the steps of:
determining the amplitude of the interfering signal component of the second processed signal;
determining the amplitude of the interfering signal component of the third processed signal;
comparing the amplitude of the interfering signal component of the reference processed RF signal with the interfering signal components of the second and third processed signals;
maintaining the current reference delay time if the amplitude of the interfering signal component of the referenced processed RF signal is relatively lower than the amplitudes of the interfering signal components of both the second and third processed signals;
decreasing the reference delay time if the amplitude of the interfering signal component of the second processed signal is relatively lower than the amplitude of the interfering signal components of both the referenced processed RF signal and the third processed signal; and
increasing the reference time delay if the amplitude of the interfering signal component of the third processed signal is relatively lower than the amplitude of the interfering signal components of both the referenced processed RF signal and the second processed signal.

5. The method according to claim 1 wherein determining step (d) comprises the step of detecting the amplitude of the interfering signal component of the reference processed RF signal.

6. The method as defined in claim 4 wherein the step of determining the amplitude of the interfering signal component of the second processed signal comprises the step of detecting the amplitude of the interfering signal component of the second processed signal.

7. The method according to claim 4 wherein the step of determining the amplitude of the interfering signal component of the third processed signal comprises the step of detecting the amplitude of the interfering signal component of the third processed signal.

8. The method according to claim 3 wherein prior to varying step (e), the method further comprises the step of filtering the reference processed RF signal, and the second and third processed signals to remove the information component.

9. The method according to claim 1 wherein processing step (c) comprises the step of subtracting the delayed RF signal from the received RF signal.

10. The method according to claim 3 wherein the step of processing the second delayed RF signal with the received RF signal comprises the step of subtracting the second delayed RF signal from the received RF signal.

11. The method according to claim 3 wherein the step of processing the third delayed RF signal with the received RF signal comprises the step of subtracting the third delayed RF signal from the received RF signal.

12. The method according to claim 3 further comprising the step filtering the reference RF signal and the second and third processed signals to remove the information component.

13. The method according to claim 12 wherein the filtering step comprises the step of inputting the processed reference RF signal, the second and third processed signals into respective band pass filters, each filter having a pass band and a center frequency, the varying step (e) further comprising varying the center frequency of the pass bands of the filters to match the characteristic frequency of the interfering signal component.

14. An apparatus for rejecting an interfering signal introduced into an information signal, comprising:
an RF signal input interface for receiving an RF signal having an information component and an interfering signal component having a varying characteristic frequency;
means for delaying the RF signal by a reference delay time that is equal to a predetermined number of periods of the characteristic frequency to form a delayed RF signal;
means for processing the RF signal and the delayed RF signal to form a processed reference RF signal in which the information component is substantial and the interfering signal component is negligible;
means for determining the amplitude of the interfering signal component of the processed reference RF signal; and
means for varying the delay of the RF signal as the characteristic frequency of the interfering signal component changes in order to maintain the interfering signal component of the processed reference RF signal at a minimum level.

15. The apparatus according to claim 14 wherein the delaying means further comprises means for simultaneously providing (i) a second delayed RF signal that is delayed, with respect to the RF signal, by an amount of time that is less than the reference delay time, (ii) a third delayed RF signal that is delayed, with respect to the RF signal, by an amount of time that is greater than the reference delay time.

16. The apparatus according to claim 15 further comprising:
a first means for processing the second delayed RF signal with the received RF signal to provide a second processed signal; and
a second means for processing the third delayed RF signal with the received RF signal to provide a third RF signal.

17. The apparatus according to claim 16 further comprising:
a first means for determining the amplitude of the interfering signal component of the second processed signal;
a second means for determining the amplitude of the interfering signal component of the third processed signal;
comparing the amplitude of the interfering signal component of the reference processed RF signal with the interfering signal components of the second and third processed signals;
means for maintaining the current reference delay time if the amplitude of the interfering signal component of the referenced processed RF signal is relatively lower than the amplitudes of the interfering signal components of both the second and third processed signals;
means for decreasing the reference delay time if the amplitude of the interfering signal component of the second processed signal is relatively lower than the amplitude of the interfering signal components of both the referenced processed RF signal and the third processed signal; and
means for increasing the reference time delay if the amplitude of the interfering signal component of the third processed signal is relatively lower than the amplitude of the interfering signal components of both the referenced processed RF signal and the second processed RF signal.
